(19) United States
(12) Patent Application Publication
(10) Pub. No.: US 2019/0168437 A1
(43) Pub. Date: Jun. 6, 2019

(54) METHOD AND APPARATUS FOR PRODUCING A CORRUGATED TUBE

(71) Applicant: Dr. Ing. h.c. F. Porsche Aktiengesellschaft, Stuttgart (DE)

(72) Inventor: Sven Auch, Stuttgart (DE)

(21) Appl. No.: 16/208,863

(22) Filed: Dec. 4, 2018

(30) Foreign Application Priority Data
Dec. 5, 2017 (DE) 10 2017 128 805.8

(51) Int. Cl. B29C 49/00; B26F 1/00

(52) U.S. Cl. CPC B29C 49/0021; B29C 47/0033; B29C 47/126; B29L 2016/00; B26F 1/0069; B29C 2791/006; B29C 2791/007; B29C 47/0023

(57) ABSTRACT

A method is provided for producing a corrugated tube that has, at least in sections, first outer wall regions with a first external diameter and second outer wall regions with a second external diameter that alternate in a wave-shaped manner. The first external diameter is greater than the second external diameter. The corrugated tube is produced by a plastic vacuum/blow molding process in a plastic vacuum/blow mold with a corrugator (1). One or more openings are made in at least some of the first outer wall regions. The openings are made in at least some of the first outer wall regions of the corrugated tube during the plastic vacuum/blow molding process within the corrugator (1).

### CROSS REFERENCE TO RELATED APPLICATION

This application claims priority under 35 USC 119 to German Patent Appl. No. 10 2017 128 805.8 filed on Dec. 5, 2017, the entire disclosure of which is incorporated herein by reference.

### BACKGROUND

### Field of the Invention

The invention relates to a method for producing a corrugated tube which has, at least in sections, first outer wall regions with a first external diameter and second outer wall regions with a second external diameter which alternate in a wave-shaped manner, the first external diameter being greater than the second external diameter, the corrugated tube being produced by way of a plastic vacuum/blow molding process in a plastic vacuum/blow mold with a corrugator, and one or more openings being made in at least some of the first outer wall regions. Moreover, the present invention relates to an apparatus for producing a corrugated tube which has, at least in sections, first outer wall regions with a first external diameter and second outer wall regions with a second external diameter which alternate in a wave-shaped manner, the first external diameter being greater than the second external diameter, the apparatus being configured to produce the corrugated tube by way of a plastic vacuum/blow molding process and having a corrugator for shaping the corrugated tube, and the apparatus having means for producing one or more openings in at least some of the first outer wall regions.

### Related Art

Corrugated tubes are known in the prior art and are distinguished by having first outer wall regions with a first external diameter and second outer wall regions with a second external diameter that is less than the first external diameter. The first and second outer wall regions alternate in a wave-shaped manner. The first outer wall regions with the greater external diameter frequently are called wave crests and the second outer wall regions with the correspondingly smaller external diameter frequently are called wave troughs. The different external diameters of the first and second outer wall regions provide the corrugated tube with a flexibility so that the corrugated tube can be bent to a certain extent. Corrugated tubes often are formed by a plastic vacuum/blow molding process in a plastic vacuum/blow mold. One essential component of a plastic vacuum/blow mold is referred to as a corrugator that shapes the corrugated tube. More particularly, the first and second outer wall regions of the corrugated tube are shaped within the corrugator.

Some technical applications require one or more openings to be formed in a targeted manner in at least some of the first outer wall regions of the corrugated tube. The external diameter of the first outer wall regions is greater than the external diameter of the second outer wall regions, and the openings may be provided to permit a discharge fluid from the corrugated tube.

U.S. Pat. No. 8,550,807 discloses a method and apparatus for producing a corrugated tube using a plastic vacuum/blow molding process in a plastic vacuum/blow mold. The apparatus has a punching apparatus that can be actuated by an actuator to form one or more openings in at least some of the first outer wall regions of the corrugated tube after the production of the corrugated tube.

It is an object of the invention to provide a method and an apparatus for producing a corrugated tube so that openings can be made in the first outer wall regions of the corrugated tube in a particularly simple way.

### SUMMARY

A method according to the invention for producing a corrugated tube is distinguished by the fact that the openings are made in at least some of the first outer wall regions of the corrugated tube during the plastic vacuum/blow molding process within the corrugator. Thus, unlike the prior art, the method does not rely on forming the openings in the selected first outer wall regions only after the conclusion of the plastic vacuum/blow molding process. The openings are to be in at least some of the first outer wall regions, and hence in regions of the corrugated tube that have an external diameter greater than the external diameter of the second outer wall regions. The openings are formed during the shaping process of the corrugated tube within the corrugator. As a result, it advantageously is not necessary to provide separate tools to make one or more openings in the relevant first outer wall regions after the corrugated tube has been formed. Thus, the method simplifies the production of the openings within the first outer wall regions and also simplifies the overall production of the corrugated tube, with corresponding cost savings.

The openings can be produced with the aid of mandrels that are arranged in at least some of the shaping recesses within the corrugator that are provided for forming the first outer wall regions. One or more mandrels can be arranged in the relevant shaping recesses depending on the number of openings that are to be produced in the respective first outer wall region.

In one embodiment each of the mandrels is arranged fixedly in the shaping recesses.

Openings with a diameter of from approximately 0.5 mm to approximately 1 mm can be produced in at least some of the first outer wall regions of the corrugated tube.

An apparatus according to the invention for producing a corrugated tube comprises means for producing one or more openings in at least some of the first outer wall regions of the corrugated tube during the plastic vacuum/blow molding process within the corrugator. The apparatus enables the openings to be produced in the relevant first outer wall regions of the corrugated tube during the actual shaping process within the corrugator. Subsequent processing of the corrugated tube, for example by means of a punching apparatus to produce the openings, is therefore advantageously not necessary. One advantage of the apparatus according to the invention is that the costs for the production of corrugated tubes can be reduced, since complicated reworking steps for producing the openings in the respective first outer wall regions can be avoided.

The means for producing one or more openings in at least some of the first outer wall regions of the corrugated tube may comprise mandrels that are arranged in at least some shaping recesses in the corrugator for shaping the first outer wall region of the corrugated tube. One or more mandrels can be arranged in the relevant shaping recesses depending on the number of openings that are to be produced in the respective first outer wall region of the corrugated tube. Each of the mandrels can be arranged fixedly in the corresponding shaping recesses of the corrugator.

In one embodiment, the mandrels can be configured to produce openings in at least some of the first outer wall regions of the corrugated tube. The openings may have a diameter of from approximately 0.5 mm to approximately 1 mm.

Further features and advantages of the invention will become clearer from the following description of one embodiment with reference to the drawing.

### BRIEF DESCRIPTION OF THE DRAWINGS

FIG. 1 is a section through a part of a corrugator 1 of an apparatus for producing a corrugated tube from plastic.

### DETAILED DESCRIPTION

A corrugated tube in accordance with an embodiment of the invention can be made from plastic and can have first outer wall regions with a first external diameter and second outer wall regions with a second external diameter. The first and second outeer wall regions alternate in a wave-shaped manner. The first external diameter is greater than the second external diameter. Thus, the first outer wall regions with the greater external diameter frequently are called wave crests, and the second outer wall regions with the correspondingly smaller external diameter are also called wave troughs. The first and second external diameters of different magnitude achieve a situation where the corrugated tube is flexible and can be bent to a certain degree.

The apparatus for producing a corrugated tube is configured to produce the corrugated tube in a plastic vacuum/blow molding process, as is well known from the prior art and therefore is not described in greater detail at this point. The apparatus has a corrugator 1 that functions to shape the corrugated tube with its first outer wall regions (wave crests) and its second outer wall regions (wave troughs). The corrugator 1 comprises shaping recesses 3a, 3b that follow one another, are configured within a half die 5 and, in particular, are of partially annular configuration. Furthermore, partial vacuum ducts 6 are flow-connected in each case to one of the shaping recesses 3a, 3b and are configured within the half die 5. In this way, a partial vacuum can be generated within the shaping recesses 3a, 3b by means of the partial vacuum ducts 6 during the shaping of the corrugated tube.

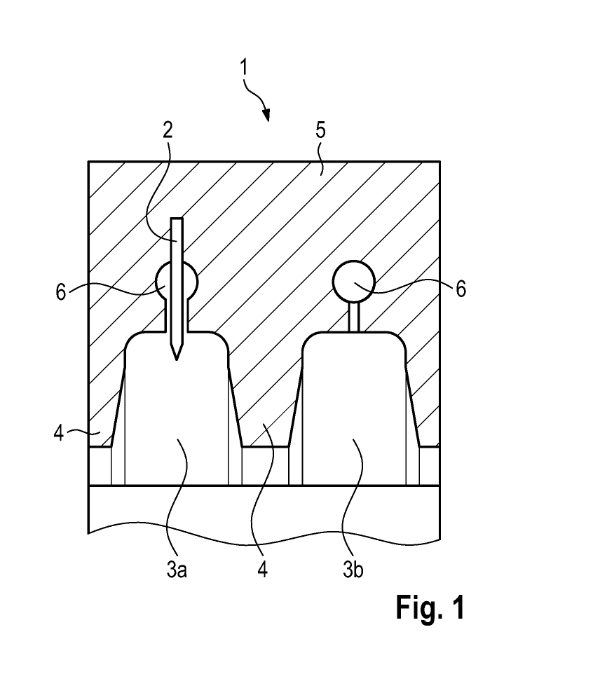

Two adjacent shaping recesses 3a, 3b are separated from one another in each case by a shaping projection 4. Thus, as shown in FIG. 1, the shaping recesses 3a, 3b are provided for shaping the first outer wall regions of the corrugated tube with the first (greater) external diameter, and the shaping projections 4 are provided for shaping the second outer wall regions of the corrugated tube with the second (smaller) external diameter. During the production of the corrugated tube, two half dies 5 that correspond with one another shape the first and second outer wall regions, each of the partially annular shaping recesses 3a, 3b of one of the two half dies 5 shaping in each case one half of the respective first and second outer wall regions of the corrugated tube.

At least some of the first outer wall regions of the corrugated tube with the first (greater) external diameter may require one or more openings, for example, to make a defined discharge of fluid from the corrugated tube possible. Thus, at least one mandrel 2 is provided in at least some of the shaping recesses 3a, 3b to produce these openings during the shaping process of the corrugated tube within the corrugator 1. The mandrel 2 can produce an opening in one of the first outer wall regions of the corrugated tube and may be arranged fixedly in the relevant shaping recesses 3a, 3b. More particularly, the resin that will form the corrugated tube expands radially out and toward the inwardly facing circumferential surface defined by the annular shaping recesses 3a, 3b due to the vacuum applied at the vacuum ducts 6. The mandrel 2 projects radially in and beyond the inwardly facing circumferential surface defined by the annular shaping recesses 3a, 3b. The mandrels 2 will pierce through the resin that is expanded outward in the respective half die 5. This piercing by the mandrel 2 can be facilitated by providing a mandrel 2 with a radially inwardly directed point, as illustrated in the FIGURE.

The openings can be produced in the relevant first outer wall regions of the corrugated tube during the actual shaping process within the corrugator 1. Reworking of the corrugated tube, for example by a punching apparatus for producing the openings, is therefore no longer necessary. As a result, a situation advantageously is achieved where the costs for the production of the corrugated tubes can be reduced, since complicated reworking steps for producing the openings in the respective first outer wall regions can be avoided.

What is claimed is:

1. A method for producing a corrugated tube that has first outer wall regions with a first external diameter and second outer wall regions with a second external diameter, the first and second outer wall regions alternating in a wave-shaped manner, the first external diameter being greater than the second external diameter, the corrugated tube being produced by a plastic vacuum/blow molding process in a plastic vacuum/blow mold with a corrugator, and one or more openings being made in at least some of the first outer wall regions, the method comprising forming the openings in at least some of the first outer wall regions of the corrugated tube during the plastic vacuum/blow molding process within the corrugator.

2. The method of claim 1, wherein the step of forming the openings comprises forming the openings with the aid of mandrels arranged in at least some shaping recesses in the corrugator for shaping the first outer wall regions.

3. The method of claim 2, wherein each of the mandrels is arranged fixedly in one of the shaping recesses.

4. The method of claim 1, wherein the step of forming the openings comprises forming the openings to have a diameter of from approximately 0.5 mm to approximately 1 mm in at least some of the first outer wall regions of the corrugated tube.

5. An apparatus for producing a corrugated tube that has first outer wall regions with a first external diameter and second outer wall regions with a second external diameter, the first external diameter being greater than the second external diameter, and the first and second external diameters alternating in a wave-shaped manner, the apparatus being configured to produce the corrugated tube by a plastic vacuum/blow molding process and having a corrugator for shaping the corrugated tube, and the apparatus having means for producing one or more openings in at least some of the first outer wall regions, wherein the means for producing one or more openings are configured to make the openings in at least some of the first outer wall regions of the corrugated tube during the plastic vacuum/blow molding process within the corrugator.

6. The apparatus of claim 5, wherein the means for producing one or more openings in at least some of the first outer wall regions comprises at least one mandrel arranged in at least some shaping recesses within the corrugator for shaping the first outer wall regions of the corrugated tube.

7. The apparatus of claim 6, wherein the at least one mandrel is arranged fixedly in the shaping recesses of the corrugator.

8. The apparatus of claim 6, wherein the at least one mandrel is configured to produce at least one opening having a diameter of from approximately 0.5 mm to approximately 1 mm.
